(19) United States
(12) Patent Application Publication
(10) Pub. No.: US 2014/0232884 A1
(43) Pub. Date: Aug. 21, 2014

(54) AUXILIARY FOCUSING SYSTEM FOR AN IP CAMERA

(71) Applicant: BRICKCOM CORPORATION, HsinChu Hsien (TW)

(72) Inventor: CI-FANG SYU, HsinChu Hsien (TW)

(73) Assignee: Brickcom Corporation, HsinChu Hsien (TW)

(21) Appl. No.: 13/768,398

(22) Filed: Feb. 15, 2013

(51) Int. Cl. G06F 3/00

(52) U.S. Cl. CPC G06F 3/005
USPC 348/207.11

(57) ABSTRACT

The present invention discloses an auxiliary focusing system for an IP camera. The auxiliary focusing system utilizes an image sensor module to determine whether the focusing is accomplished. Display devices (such as indicator lights, displays) and audio devices (such as buzzers, speakers) are used to inform a user whether the images have been focused clearly.

### BACKGROUND OF THE INVENTION

a) Field of the Invention

The present invention relates to an auxiliary focusing system for an IP (Internet Protocol) camera, and more particularly to a system using an indication or audio device to display the focus state.

b) Description of the Prior Art

The IP cameras are divided into a manual focusing type and an automatic focusing type, wherein the manual focusing needs to be done by a person. Depending upon applications, the camera is installed at a high place or a specific location; whereas, an operator needs to wear a computer or a small analog screen with him or her to ensure the images are focused. Hence, it is difficult to accomplish the focusing accurately in a short time, thereby wasting a lot of labor hours.

Accordingly, how to develop a convenient and accurate focusing method is to be pursued by the present inventor.

### SUMMARY OF THE INVENTION

Accordingly, the primary object of the present invention is to provide an auxiliary focusing system for an IP camera, wherein an indication or audio device (such as an indicator light or a buzzer that is used hereinafter) is installed on an IP camera assembly, so that when the images manifest various focus states during the focusing operation, the focus states can be informed to a user by the indicator light or buzzer.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a simplified functional diagram of a preferred embodiment of an IP camera module, according to the present invention.

FIG. 2 shows a perspective view of a preferred embodiment of a focusing device for an IP camera, according to the present invention.

FIG. 3 shows an exploded view of a preferred embodiment of a focusing device for an IP camera, according to the present invention.

FIG. 4 shows a schematic view of a preferred embodiment of a lens module of an IP camera focusing device, according to the present invention.

FIG. 5 shows a flow diagram of an image data of a preferred embodiment, according to the present invention.

### DETAILED DESCRIPTION OF THE PREFERRED EMBODIMENTS

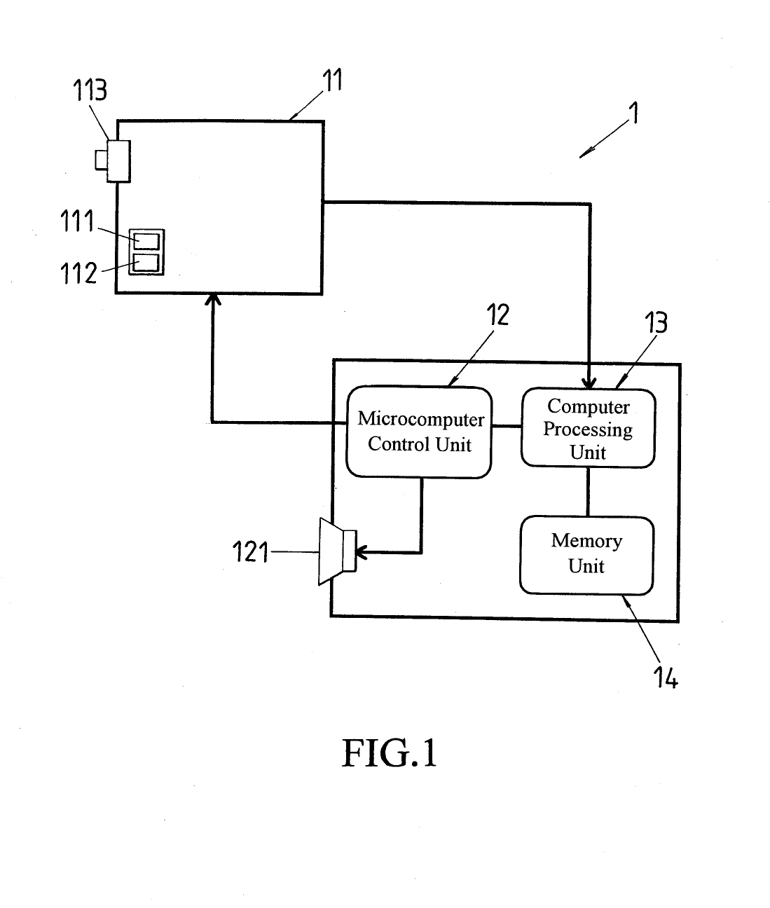

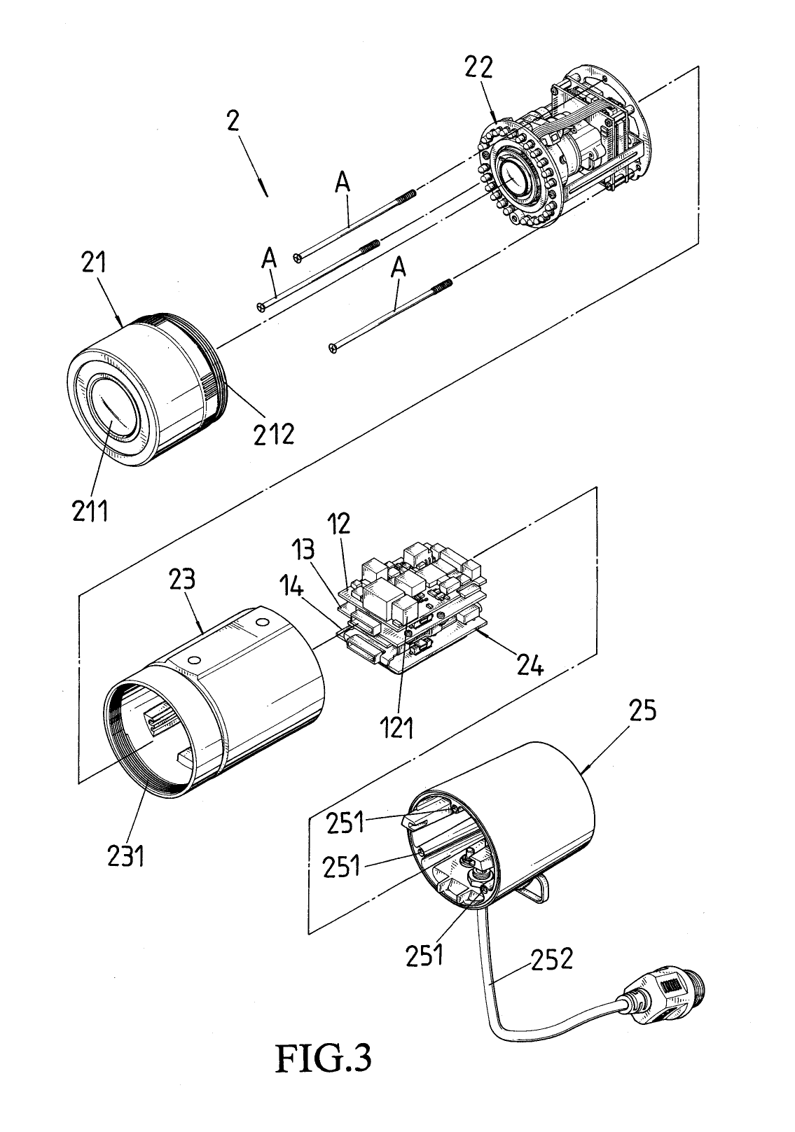

Referring to FIG. 1, an IP camera module 1 comprises an image sensor module 11, a microcomputer control unit 12, a computer processing unit 13 and a memory unit 14. The image sensor module 11 processes images through the computer processing unit 13. Referring to FIG. 3, the image sensor module 11 is installed on a lens module 22 of a camera assembly 2; whereas, the microcomputer control unit 12, the computer processing unit 13 and the memory unit 14 are installed on a circuit module 24 of the camera assembly 2. The microcomputer control unit 12 is connected electrically with the image sensor module 11 and a buzzer 121 respectively, which allows the buzzer 121 or focus indicator lights 111, 112 to prompt in an audio or light effect. On the other hand, the computer processing unit 13 is connected electrically with the microcomputer control unit 12 and the memory unit 14, respectively.

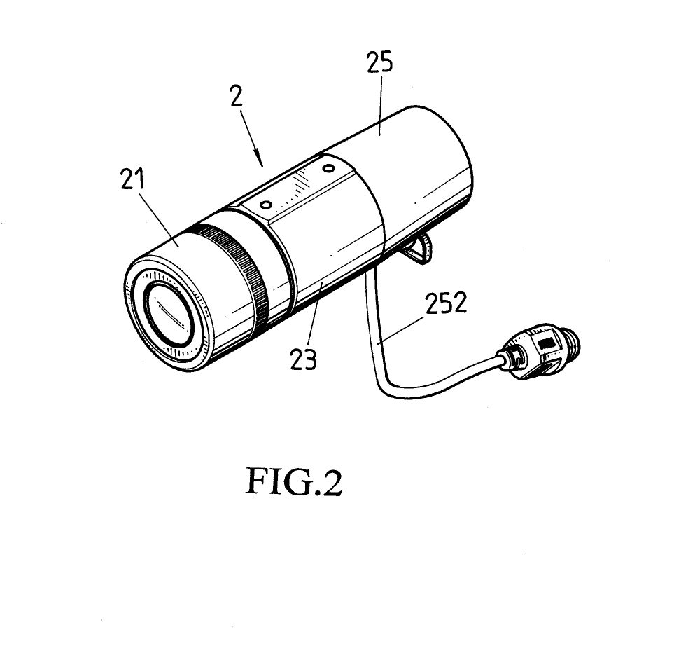

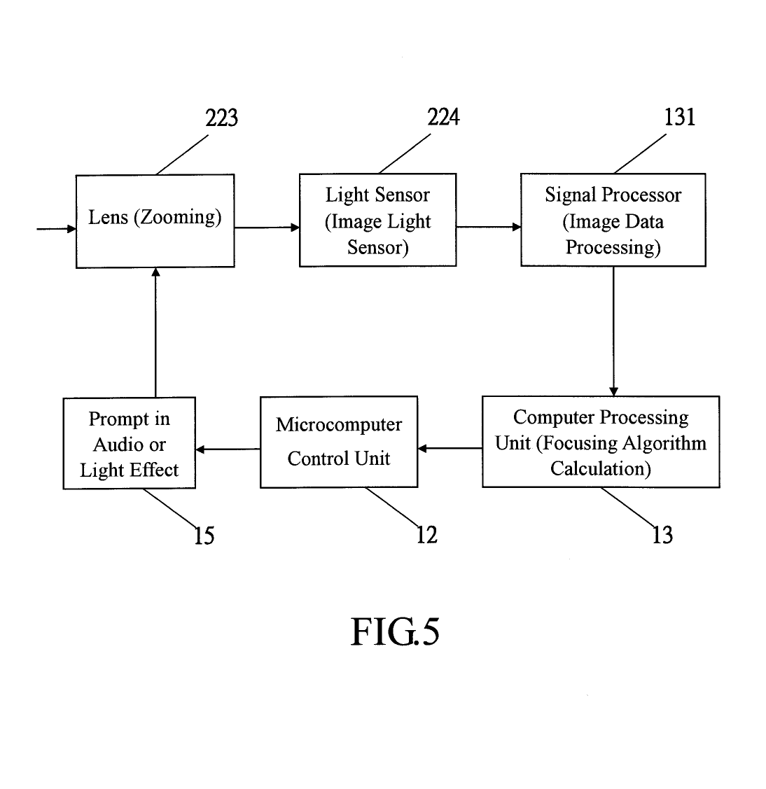

Referring to FIG. 2 and FIG. 3, the camera assembly 2 includes a front cap 21, the lens module 22, a camera body 23, the circuit module 24 and a rear cap 25. An end of the front cap 21 is provided with a cover plate 211 and the other end is provided with a male thread 212. The cover plate 211 is a piece of flat glass, allowing light to pass through and stopping impurities, such as dust, from entering into and contaminating the lens module 22. Referring to FIG. 5, an interior of the lens module 22 is installed with a zoom lens 223 and an image light sensor 224. An end of the computer processing unit 13 is connected with a signal processor 131, and the signal processor 131 is connected electrically with the image light sensor 224. Three long screws A penetrate from an interior side of the front cap 21 into the lens module 22 and the circuit module 24, and are then locked and positioned into bolt holes 251 of the rear cap 25. A front rim of the camera body 23 is provided with a female thread 231 which is locked with the male thread 212 of the front cap 21. An end of the rear cap 25 is connected with a network cable 252 to connect to the network. The primary characteristics of the present invention are disclosed below.

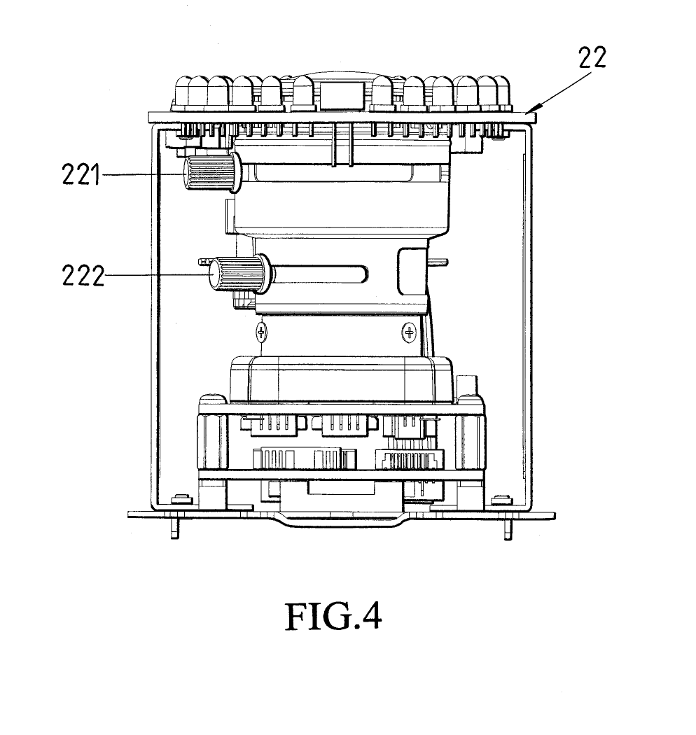

Referring to FIG. 1, the image sensor module 11 is installed with a red and green focus indicator light 111, 112 and a focus button 113 which is connected electrically with the focus indicator lights 111, 112. On the other hand, an end of the microcomputer control unit 12 is connected electrically with the buzzer 121. Referring to FIG. 4, the lens module 22 is provided with a focus control lever 221 and a zoom control lever 222. The flow of image data of the present invention is described briefly below:

1. Referring to FIG. 5, the image light sensor 224 converts light transmitted from the zoom lens 223 into an analog induction voltage and transmits this voltage to the signal processor 131 of the circuit module 24; whereas, the signal processor 131 converts this voltage into a digital image signal and conducts image data processing. After the image data has been compressed by the computer processing unit 13, the image data is stored in the memory unit 14 (as shown in FIG. 1).

2. The computer processing unit 13 performs a focusing algorithm calculation to the image data for a zoom control, the microcomputer control unit 12 controls a prompt in an audio or light effect 15 and the zoom lens 223 is adjusted manually to zoom out or zoom in.

3. For a variable focus control of the zoom lens 223, when the user activates the focus button 113 to set the zoom control lever 222 at Tele or Wide, he or she rotates manually the focus control lever 221 to focus conveniently.

4. When the focus state is vague, the red focus indicator light 111 will flash continuously and the buzzer 121 will buzz constantly.

5. When the focus state is close to a clear state, the red focus indicator light 111 will extinguish and the green focus indicator light 112 will flash continuously, but the buzzer 121 will silence.

6. When the focus state is clear, the green focus indicator light 112 will illuminate constantly.

As is apparent from the foregoing, the primary object of the present invention is to provide an auxiliary focusing system for an IP camera, when manually adjusting the zoom lens, the user can accurately accomplish the focusing operation only by the flashing or illumination of the focus indicator lights or by the sound of the buzzer, which is an easy and accurate focusing process. Therefore the present invention is an innovated creation.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An auxiliary focusing system for an IP (Internet Protocol) camera, wherein an IP camera module of the system comprises:
an image sensor module, the image sensor module being installed with a red and green focus indicator light and a focus button which is connected electrically with the focus indicator lights;
a microcomputer control unit, the microcomputer control unit being connected electrically with the image sensor module and an end of the microcomputer control unit being connected electrically with a buzzer;
a computer processing unit, the computer processing unit being connected electrically with the microcomputer control unit, and the image sensor module processing images through the computer processing unit; and
a memory unit, the memory unit being connected electrically with the computer processing unit to store the image data after the image data has been compressed by the computer processing unit.

2. The auxiliary focusing system for an IP camera, according to claim 1, wherein the image sensor module is installed on a lens module of a camera assembly.

3. The auxiliary focusing system for an IP camera, according to claim 1, wherein the microcomputer control unit, the computer processing unit and the memory unit are installed on a circuit module of a camera assembly.
